(19) United States
(12) Patent Application Publication
(10) Pub. No.: US 2015/0052045 A1
(43) Pub. Date: Feb. 19, 2015

(54) SYSTEMS AND METHODS FOR INSTANT FUNDING OF FINANCIAL SERVICE PRODUCTS

(71) Applicant: Capital One Financial Corporation, McLean, VA (US)

(72) Inventors: Brian De Luca, Midlothian, VA (US); David Gwynne, Glen Allen, VA (US); Anurag Joshi, Glen Allen, VA (US); Rawley Pieratt, Richmond, VA (US)

(73) Assignee: Capital One Financial Corporation, McLean, VA (US)

(21) Appl. No.: 14/461,615

(22) Filed: Aug. 18, 2014

Related U.S. Application Data
(60) Provisional application No. 61/867,392, filed on Aug. 19, 2013.

(51) Int. Cl. G06Q 40/02; G06Q 20/10

(52) U.S. Cl. CPC G06Q 40/02; G06Q 20/10
USPC 705/39

(57) ABSTRACT

Systems and methods are disclosed for opening new accounts, immediately funding those accounts, and supplying users with funded debit cards within a single visit. According to disclosed embodiments, a financial services kiosk or a combination of financial services systems is configured to open a new account, transfer funds to the new account via a modified withdrawal, a modified debit purchase, a real-time network transfer, and/or an immediate ACH transfer, and print an active debit card for the user without the typical delay of several days or weeks between the opening of the account, the funding of the account, and the issuance of a debit card.

### CROSS-REFERENCE TO RELATED APPLICATION

This application claims priority to U.S. Provisional Application No. 61/867,392, filed Aug. 19, 2013, the entire contents of which is hereby incorporated by reference.

### FIELD

The disclosed embodiments generally relate to the creation and funding of new accounts and the issuance of debit cards and, in particular, creating and funding new bank accounts and issuing debit cards to customers that can be immediately funded and used by the customer before the customer leaves the debit card issuing facility.

### BACKGROUND

A customer attempting to obtain an active, funded debit card for a new bank account is faced with several obstacles and delays. For example, if a customer opens a new bank account, the bank often requires the account to be funded before a debit card is issued. To fund the account, a customer need to deposit cash, deposit a check, or request a transfer of funds from another account. These options are not convenient because customers may not carry sums of cash for deposit, may be forced to visit a bank and use a live teller to make a cash deposit, may be forced to wait several days for a deposited check to clear, may not have the account information readily available for a transfer from another account, and/or may be forced to wait several days for the account transfer to complete. Once the account is funded, it may take days or even weeks for the active and funded debit card to be mailed to the customer.

These hurdles decrease customers' usage of debit cards. Not only is usage decreased because the customer is unable to use the debit card until it is received in the mail, but also the longer the time between opening the account and using the debit card for the first time, the less likely the customer will use that card regularly.

Accordingly, a need exists to remove the hurdles to obtaining a funded debit card, and to allow customers to use debit cards as soon as a new bank account is opened. A need also exist for increasing adoption of debit card usage by providing customers with the ability to fund and use the debit card to transfer funds as a part of the new account opening process.

### SUMMARY

Disclosed embodiments include systems and processes for funding a new account and issuing a new debit card associated with the new account.

In certain embodiments, a system for funding a new account is provided comprising a memory storing instructions and a processor configured to execute the instructions. The instructions include instructions to create a new account via one or more processors, request a selection of an amount and/or a transaction type for funding the new account, and receive the selection of the amount and/or the transaction type for funding the new account. The instructions may also include instructions to receive identification information for a funding source account, request a transfer of funds from the funding source account to new account, and deposit the transferred funds into the new account. The processor may be further configured to execute the instructions to determine, when the received selection is a selection of the amount for funding the new account, the transaction type for funding the new account before requesting the transfer of funds from the funding source account to the new account, where the determination is based on the amount selected. The processor may also be further configured to execute the instructions to transmit instructions to a printer to print a new debit card associated with the new account and/or transmit instructions to the printer after the transferred funds are deposited into the new account. The processor may also be configured to execute the instructions to receive information about a potential new account holder before creating the new account, determine where the received information about the potential new account holder is sufficient to create the new account, request missing information when the received information about the potential new account holder is not sufficient, and create the new account when sufficient information is received.

In certain embodiments, an apparatus for funding a new account is provided comprising a processor, a user interface, a card printer, and a memory. The memory may contain instructions for an application module, an account creation module, a fund transfer module, and/or a card issuance module. The instructions in the application module, when executed by the processor, may (1) present requests via the user interface for information required to create a new account, and (2) receive information via the user interface. The instructions in the account creation module may create a new account. The instructions in the fund transfer module may request a transfer of funds from a source account to the new account. The instructions in the card issuance module may send instructions to the card printer to print a new card associated with the new account.

In certain embodiments, a computer-implemented method for funding a new account is provided, comprising creating, via at least one processor, a new account via one or more processors, requesting a selection of an amount and/or a transaction type for funding the new account, receiving the selection of the amount and/or the transaction type for funding the new account, receiving identification information for a funding source account, requesting, via the at least one processor, a transfer of funds from the funding source account to new account, and depositing the transferred funds into the new account. The received selection may be a selection of the amount for funding the new account; and the method may further comprise determining, via the at least one processor, the transaction type for funding the new account before requesting the transfer of funds from the funding source account to the new account, the determination based on the amount selected. The method may further comprise transmitting instructions to a printer to print a new debit card associated with the new account. The printing of the new debit card may occur after the transferred funds are deposited into the new account. The method may also comprise receiving information about a potential new account holder before creating the new account, determining whether the received information about the potential new account holder is sufficient to create the new account, requesting missing information when the received information about the potential new account holder is not sufficient, and creating the new account when sufficient information is received.

Additional objects and advantages of the disclosed embodiments will be set forth in part in the description which follows, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed. For example, the methods relating to the disclosed embodiments may be implemented in system environments outside of the exemplary system environments disclosed herein.

### BRIEF DESCRIPTION OF THE DRAWINGS

The accompanying drawings, which are incorporated in and constitute a part of this specification, illustrate various embodiments and aspects of the disclosed embodiments and, together with the description, serve to explain the principles of the disclosed embodiments. In the drawings:

FIG. 1 illustrates an exemplary integrated system consistent with disclosed embodiments;

FIG. 2 illustrates an exemplary distributed system consistent with disclosed embodiments;

FIG. 3 is a flowchart of an exemplary debit card funding process from the perspective of a user consistent with disclosed embodiments;

FIG. 4 is a flowchart of an overview of an exemplary debit card funding process consistent with disclosed embodiments;

FIG. 5 is a flowchart of an algorithm of an exemplary debit card funding process consistent with disclosed embodiments; and

FIG. 6 is a flowchart of an exemplary debit card funding process using a system consistent with disclosed embodiments.

### DETAILED DESCRIPTION

Reference will now be made in detail to disclosed embodiments, examples of which are illustrated in the accompanying drawings. Wherever convenient, the same reference numbers will be used throughout the drawings to refer to the same or like parts.

Generally, disclosed embodiments are directed to systems and methods for providing potential account holders with a new account and an active, funded debit card during a single visit to a financial institution or ATM, kiosk, or other apparatus of a financial institution. The entire process, from completion of the application to open the new account to receipt of an active, funded debit card can typically be completed in less than fifteen minutes. In some cases, the entire process may be completed in less than five minutes. For ease of discussion, embodiments may be described in connection with the opening of bank accounts and issuing of debit cards. It is to be understood, however, that disclosed embodiments are not limited to bank accounts and debit cards, and, in fact, may be applied to any account, whether new or previously established, and to the issuance of any card or similar device associated with an account. Further, steps or processes disclosed herein are not limited to being performed in the order described, but may be performed in any order, and some steps may be omitted, consistent with the disclosed embodiments.

The features and other aspects and principles of the disclosed embodiments may be implemented in various environments. Such environments and related applications may be specifically constructed for performing the various processes and operations of the disclosed embodiments, including a computing platform selectively activated or configured by program code to provide the necessary functionality. The processes disclosed herein may be implemented by a suitable combination of hardware, software, and/or firmware. For example, the disclosed embodiments may implement a specialized apparatus or system, such as a financial services kiosk or Automated Teller Machine (ATM), configured to execute software programs that perform processes consistent with the disclosed embodiments. Furthermore, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low level software instructions, such as machine code (e.g., such as that produced by a compiler) and/or high level code that can be executed by a processor using an interpreter.

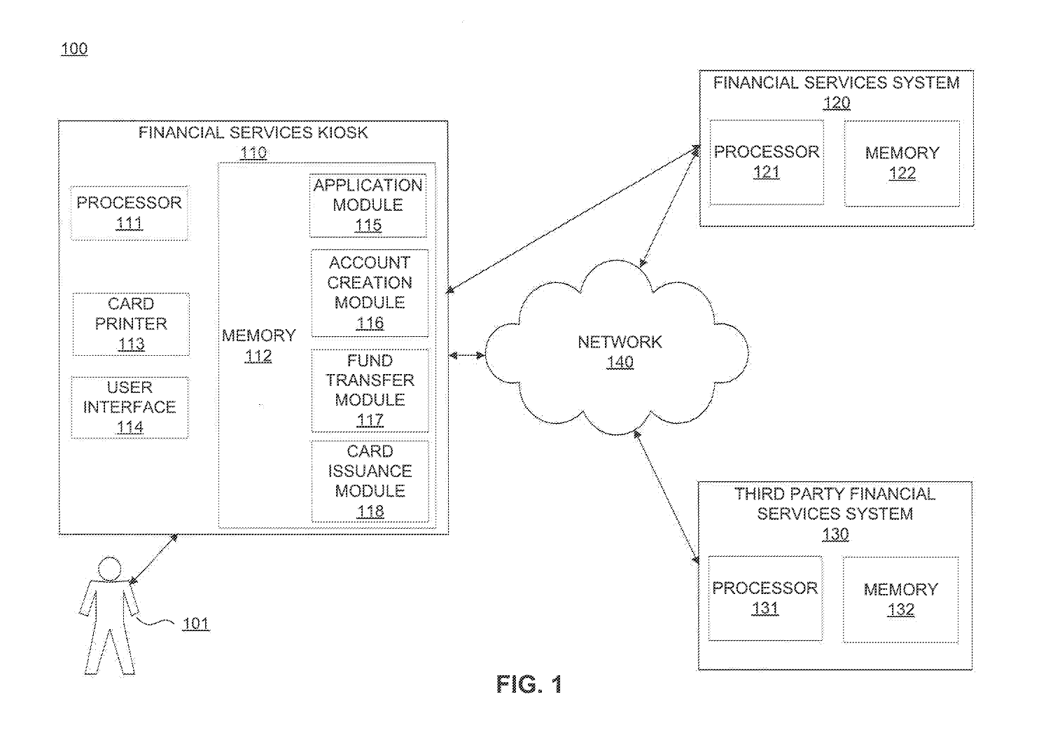

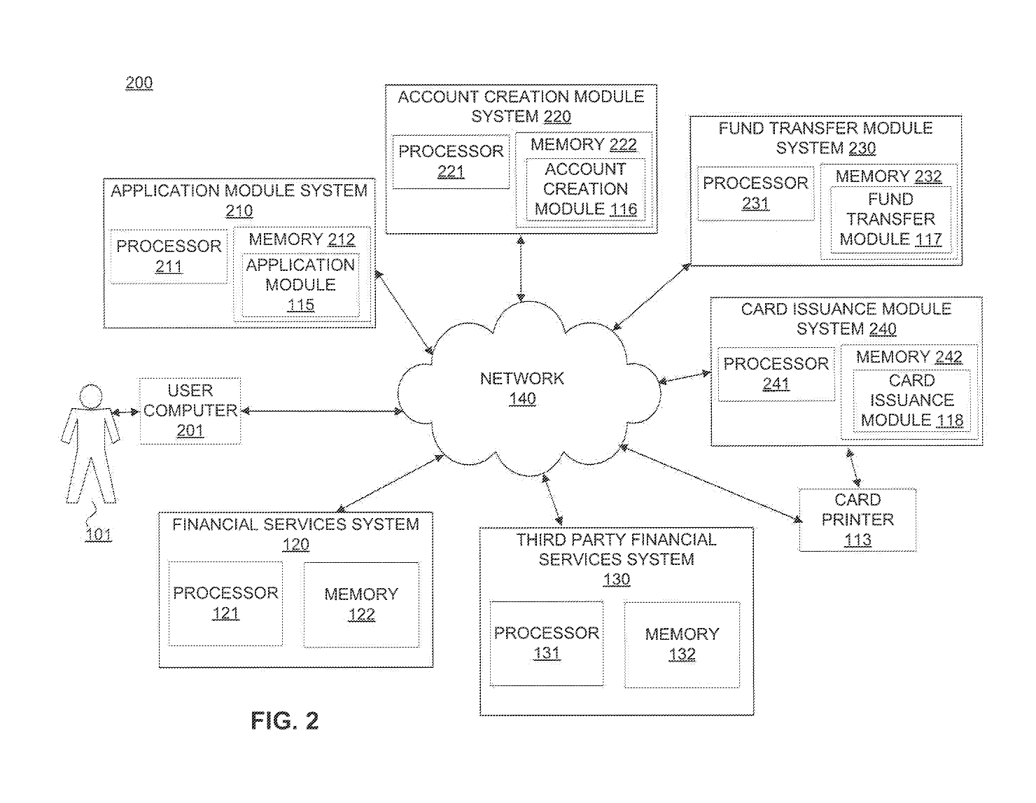

FIG. 1 illustrates exemplary system 100 consistent with disclosed embodiments. In one aspect, system 100 may include financial services kiosk 110, financial services system 120, third party financial services system 130, and network 140. According to some embodiments, financial services kiosk 110 and financial services system 120 may both be associated with the same financial service provider. The financial service provider may be one or more entities that configure, offer, provide, and/or manage financial service accounts, such as credit card accounts, debit card accounts, checking or savings accounts, and loan accounts. System 100 represents an integrated embodiment, wherein many of the functions for creating a new account and funding a new debit card are provided by financial services kiosk 110. One of ordinary skill in the art would understand that the functions of integrated system 100 may be implemented in a more distributed system, and an example of a more distributed system is disclosed in FIG. 2 (discussed further below).

User 101 may be a potential account holder with the financial service provider associated with financial services kiosk 110. User 101 may also be a current account holder of the financial service provider associated with financial services kiosk 110 and financial services system 120. User 101 may also be a current account holder of the financial service provider associated with third party financial services system 130. In certain embodiments, user 101 may be a person acting on behalf of the individual wishing to open a new account and fund a new debit card using financial services kiosk 110. For example, user 101 may be an employee of the financial service provider associated with the financial services kiosk 110 who is assisting a potential account holder in completing the new account application and debit card funding process. User 101 may also be an entity (e.g., a company opening an account and funding a new debit card).

Financial services kiosk 110 may be a system associated with one or more entities that configure, offer, provide, and/or manage financial service accounts, such as credit card accounts, debit card accounts, checking or savings accounts, and loan accounts. In some embodiments, the financial services kiosk 110 may be a stand-alone kiosk or other such unit within a brick and mortar banking location. The brick and mortar location may be associated with financial services system 120. In alternative embodiments, the stand-alone kiosk may be situated at a location affiliated with other merchants, such as at a retail shopping mall.

Consistent with the disclosure, financial services kiosk 110 may provide user interface 114 for requesting and receiving input from user 101. Financial services kiosk 110 may include a card reader for receiving information from a card, such as a credit or debit card. In some embodiments, financial services kiosk 110 may send requests for transfers of funds to and receive transfers of funds from financial services system 120. Financial services kiosk 110 may be directly connected and/or incorporated into financial services system 120. Alternatively, financial services kiosk 110 may be connected to financial services system 120 via network 140. Financial services kiosk 110 may also process other transaction services, such as those provided by a typical Automated Teller Machine (ATM) (e.g., cash withdrawals, check deposits, etc.). Financial services kiosk 110 may also include card printer 113 for printing new debit cards associated with new accounts. In some embodiments, financial services kiosk 111 comprises one or more processors 111 and one or more memories 112. Memory 112 may store instructions for application module 115, account creation module 116, fund transfer module 117, and/or card issuance module 118. Application module 115 may contain instructions that, when executed by the processor, present an application and/or request information from user 101 necessary to open a new account. Application module 115 may also receive information and responses from user 101 which can then be used by account creation module 116 to create a new account. Application module 115 or account creation module 116 may be configured to determine whether all necessary information for opening a new account has been provided by user 101. If necessary information is missing, application module 115 may prompt the user to supply the additional information or account creation module 116 may be configured to direct application module 115 to request the additional information. Application module 115 may send requests and receive information from user 101 via user interface 114.

As indicated above, account creation module 116 may create a new account once all of the necessary information for the new account is received from user 101. Additionally, account creation module 116 may create a new account after receiving the necessary information from user 101 and after receiving information from the financial service provider associated with financial services kiosk 110. For example, account creation module 116 may be in communication with financial services system 120 in order to create a new account. The information for the new account may be transmitted from account creation module 116 to financial services system 120 for storage in memory 122. In some embodiments, creation of the new account may occur at financial services system 120 after receiving information for the account from account creation module 116. Alternatively, creation of the new account may occur at financial services kiosk 110, and then information about the new account may be transmitted to financial services system 120.

Fund transfer module 117 may be configured to request whether user 101 wishes to add funds to the new account once the new account is created and to further request information needed to transfer the funds. Once fund transfer module 117 receives the information needed to transfer the funds, fund transfer module 117 may be configured to request the funds from financial services system 120 and/or third party financial services system 130, via network 140 or via a direct connection (e.g., a direct connection to financial services system 120). The type of transactions that fund transfer module 117 may be configured to request are discussed below. Fund transfer module 117 may also be configured to deposit the transferred funds into the new account.

Card issuance module 118 may be configured to associate a new debit card with a new account and transmit instructions to card printer 113 to print a new debit card. Card issuance module 118 may be configured to send instructions to print the new debit card at one of several times in the disclosed account and debit card funding processes. For example, card issuance module 118 may be configured to print an unfunded debit card after the account is created by account creation module 116 but before funds have been transferred into the new account. As another example, card issuance module 118 may be configured to print a funded debit card after the transferred funds are deposited in the new account.

Financial services kiosk 110 may include one or more components that perform processes consistent with the disclosed embodiments. For example, although financial services kiosk 110 is represented in FIG. 1 as a single integrated apparatus, financial services kiosk 110 may comprise a distributed system. For example, financial services kiosk 110 may include one or more computers (e.g., servers, database systems, embedded system or other dedicated hardware, etc.) configured to execute software instructions programmed to perform aspects of the disclosed embodiments, such as a separate card printer 113 for printing new debit cards, a separate card reader for receiving information from a card, a separate computer comprising application module 115 and user interface 114 for obtaining application information, etc. One of ordinary skill in the art would understand advantageous configurations for financial services kiosk 110. Furthermore, consistent with disclosed embodiments, financial services kiosk 110 may include other components and infrastructure that enable it to perform operations, processes, and services consistent with financial service providers, such as banking operations, credit card operations, loan operations, and, in particular, ATM operations, etc.

Financial services system 120 may represent a system associated with the same financial service provider that is associated with financial services kiosk 110. Financial services system 120 may comprise one or more processors 121 and one or more memories 122. Financial services system 120 may include one or more components that perform processes consistent with the disclosed embodiments. For example, financial services system 120 may include one or more computers (e.g., servers, database systems, embedded system or other dedicated hardware, etc.) that are configured to execute software instructions programmed to perform aspects of the disclosed embodiments. One of ordinary skill in the art would recognize that financial services system 120 may include components and infrastructure that enable it to perform operations, processes, and services such as communicating with financial services kiosk 110 or other components relating to the creation of a new account and the funding of a new debit card. Financial services system 120 may also supply information to financial services kiosk 110 necessary to create a new account, such as the terms of the new account, the number of the new account, etc. Financial services system 120 may also create and store the new account based on information transmitted from financial services kiosk 110. Additionally, financial services system 120 may store information for other accounts owned by user 101. These accounts may serve as source accounts for funding the new account.

Third party financial services system 130 may represent a system associated with a financial service provider that is not associated with financial services kiosk 110 or financial services system 120. Third party financial services system 130 may store information for other accounts owned by user 101. According to some embodiments, these accounts may serve as source accounts for funding the new account. Third party financial services system 130 may include components and infrastructure that enable it to perform operations, processes, and services consistent with financial service providers, such as receiving and responding to various types of requests for transferring funds, communicating with financial services kiosk 110, or other components relating to the transactions.

Consistent with disclosed embodiments, components of system 100, including financial services kiosk 110, financial services system 120, and third party financial services system 130, may include one or more processors (such as processors 111, 121, or 131) as shown in exemplary form in FIG. 1. Similarly, consistent with disclosed embodiments, components of system 200, described below in relation to FIG. 2, including application module system 210, account creation module system 220, fund transfer module system 230, and card issuance module system 240, may include one or more processors (such as processors 211, 221, 231, and 241), as shown in FIG. 2. The processors may be one or more known processing devices, such as a microprocessor from the Pentium™ family manufactured by Intel™ or the Turion™ family manufactured by AMD™. The processor may include a single core or multiple core processor system that provides the ability to perform parallel processes simultaneously. For example, the processors may be single core processors configured with virtual processing technologies known to those skilled in the art. In certain embodiments, the processors may use logical processors to simultaneously execute and control multiple processes. The processors may implement virtual machine technologies, or other similar known technologies to provide the ability to execute, control, run, manipulate, store, etc. multiple software processes, applications, programs, etc. In some embodiments, the processors may include a multiple-core processor arrangements (e.g., dual or quad core) configured to provide parallel processing functionalities to enable computer components of financial services kiosk 110, financial services system 120, third party financial services system 130, application module system 210, account creation module system 220, fund transfer module system 230, and/or card issuance module system 240 to execute multiple processes simultaneously. Other types of processor arrangements could be implemented that provide for the capabilities disclosed herein. Moreover, the processors may represent one or more servers or other computing devices that are associated with financial services kiosk 110, financial services system 120, third party financial services system 130, application module system 210, account creation module system 220, fund transfer module system 230, and/or card issuance module system 240. For instance, the processors may represent a distributed network of processors configured to operate together over a local or wide area network. Alternatively, the processors may be a processing device configured to execute software instructions that receive and send information, instructions, etc. to/from other processing devices associated components of systems 100 and 200. In certain aspects, processors 111, 121, 131, 211, 221, 231, and/or 241 may be configured to execute software instructions stored in memory to perform one or more processes consistent with disclosed embodiments.

Consistent with disclosed embodiments, components of system 100, including financial services kiosk 110, financial services system 120, and third party financial services system 130, may also include one or more memory devices (such as memories 112, 122, and 132) as shown in exemplary form in FIG. 1. Similarly, consistent with disclosed embodiments, components of system 200, described below in relation to FIG. 2., including application module system 210, account creation module system 220, fund transfer module system 230, and card issuance module system 240, may include one or more memory devices (such as memories 212, 222, 232, and 242), as shown in FIG. 2. The memory devices may store software instructions that are executed by processors 111, 121, 131, 211, 221, 231, and 241 such as one or more applications, network communication processes, operating system software, software instructions relating to the disclosed embodiments, and any other type of application or software known to be executable by processing devices. The memory devices may be a volatile or non-volatile, magnetic, semiconductor, tape, optical, removable, nonremovable, or other type of storage device or tangible computer-readable medium. The memory devices may be two or more memory devices distributed over a local or wide area network, or may be a single memory device. In certain embodiments, the memory devices may include database systems, such as database storage devices, one or more database processing devices configured to receive instructions to access, process, and send information stored in the storage devices.

In some embodiments, system 100 or system 200 may also include one or more additional systems for intermediary financial companies (not shown) that assist in transfers of funds between the components represented in system 100 or 200. For example, companies that provide ATM network and processing services like Metavante Technologies, Inc. or Vantiv® may operate as intermediaries facilitating the transfer of funds between the entities of system 100 (e.g., financial services kiosk 110, financial services system 120, and/or third party financial services system 130) or the entities of system 200 (e.g., financial services kiosk 110, financial services system 120, third party financial services system 130, application module system 210, account creation module system 220, fund transfer module system 230, and/or card issuance module system 240).

In some embodiments, entities of system 100 or entities of system 200 may also include one or more additional components (not shown) that provide communications with other components of system 100 or 200, such as through network 140, or any other suitable communications infrastructure.

Network 140 may be any type of network that facilitates communications and data transfer between components of system 100 or system 200. Network 140 may be a Local Area Network (LAN), a Wide Area Network (WAN), such as the Internet, and may be a single network or a combination of networks. Further, network 140 may reflect a single type of network or a combination of different types of networks, such as the Internet and public exchange networks for wireline and/or wireless communications. Network 140 may utilize cloud computing technologies that are familiar in the marketplace. Moreover, any part of network 140 may be implemented through traditional infrastructures or channels of trade, to permit operations associated with financial accounts that are performed manually or in-person by the various entities illustrated in FIG. 1 or FIG. 2. Network 140 is not limited to the above examples and system 100 or 200 may implement any type of network that allows the entities (and others not shown) included in FIG. 1 or FIG. 2 to exchange data and information.

Although FIG. 1 describes a certain number of entities and processing/computing components within system 100, any number or combination of components may be implemented without departing from the scope of the disclosed embodiments. For example, third party financial services systems 130 may interact with one or more financial services kiosks through network 140. Further, where different components of system 100 are combined (e.g., financial services kiosk 110 and financial services system 120, etc.), the computing and processing devices and software executed by these components may be integrated into a local or distributed system.

FIG. 2 illustrates exemplary distributed system 200 consistent with disclosed embodiments. Instead of the integrated system disclosed in FIG. 1, where the financial services kiosk 110 contained modules to perform many of the tasks, FIG. 2 illustrates the modules distributed into separate systems consistent with disclosed embodiments.

For example, application module 115 is now shown as a part of application module system 210, which also comprises processor 211. Account creation module 116, fund transfer module 117, and card issuance module 118 are similarly distributed into account creation module system 220, fund transfer module system 230, and card issuance module system 240, respectively, and each module system comprises a separate processor (e.g., processors 221, 231, 242, and 251). Card printer 113 is represented as a separate printer which may be directly connected to card issuance module system 240 and/or connected via network 140.

Instead of user interface 114 of financial services kiosk 110, user 101 may receive requests and input information via user computer 201, which is connected to system 200 via network 140. User computer 201 may be one or more computer systems associated with or operated by user 101. For example, user computer 201 may include a general purpose or notebook computer, a mobile device with computing ability, smart phone, a server, a desktop computer, tablet, or any combination of these computers and/or affiliated components. User computer 201 may be configured with storage that stores one or more operating systems that perform known operating system functions when executed by one or more processors. By way of example, the operating systems may include Microsoft Windows™, Unix™, Linux™, or Apple™ type operating systems. The operating systems may also include Personal Digital Assistant (PDA) type operating systems, such as Microsoft CE™, Apple iOS, or other types of operating systems. Embodiments of the disclosed invention will operate and function with computer systems running any type of operating system. User computer 201 may also include communication software that, when executed by a processor, provides communications with network 140, such as Web browser software, tablet or smart hand held device networking software, etc. Accordingly, user computer 201 may be a device that executes mobile applications, such as a tablet or mobile device.

One of ordinary skill in the art would understand that it may be advantageous to provide user interfaces for each of the module systems. Each of the module systems may be connected to each other and financial services system 120 and third party financial services system 130 via network 140.

One of ordinary skill in the art would also understand that it may be advantageous to combine one or more module systems of system 200. For example, card printer 113 may be integrated into card issuance module system 240. As another example, application module system 210 and account creation module system 220 may be integrated into one system that provides both new account application and new account creation functions. Furthermore, one or more modules of system 200 may include one or more card readers to receive information from debit or credit cards.

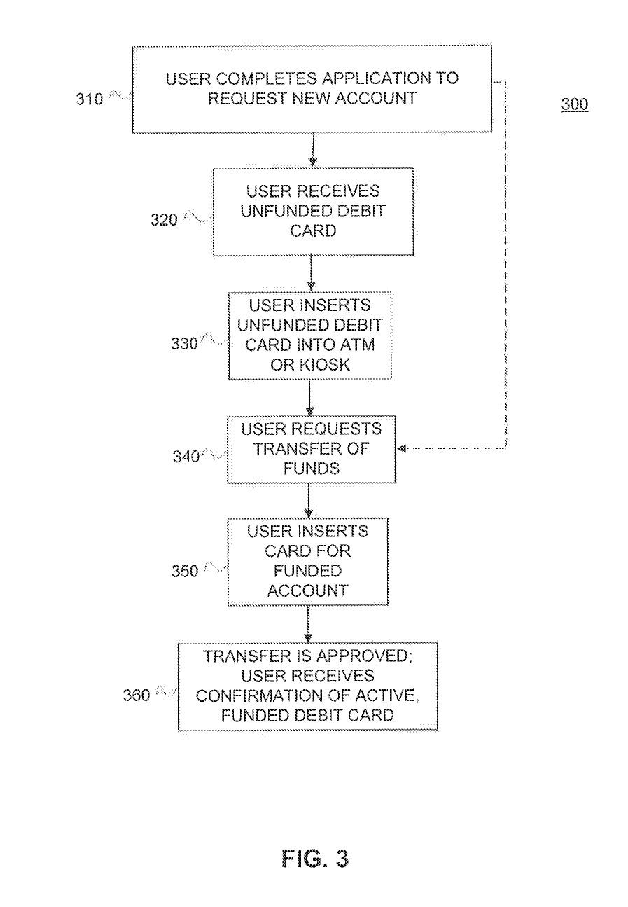

FIG. 3 is a flowchart of exemplary debit card funding process 300 from the perspective of user 101 consistent with disclosed embodiments. For ease of discussion, the disclosure of FIG. 3 assumes that user 101 is opening a new account and funding a new debit card at a system including a kiosk such as system 100 including financial services kiosk 110. One of ordinary skill in the art would understand how process 300 could be applied to other systems, including system 200.

When applying for a new account, user 101 completes an application, supplying the required information to open the new account (step 310). Such information may include, but is not limited to, name, birthdate, address, social security number, employment information, and/or financial information such as account information, income, assets, and debts. In some embodiments, the information may include digital or physical copies of government-issued identification, such as a driver's license, social security card, passport, etc. In some embodiments, the information may include proof of income, and may be received in the form of a digital or physical copy of a pay stub, paycheck, human resources document, tax return, etc. Financial services kiosk 110 (e.g., application module 115 of financial services kiosk 110) may prompt user 101 for more or less information, based on characteristics of user 101, geographical location, legal restrictions, or any other concern or consideration relating to the business of financial services kiosk 110. In some embodiments, the information is provided via user interface 114 and/or a card reader.

Kiosk 110 (e.g., application module 115) may also prompt user 101 to supply information that is not typically required for opening a new account, such as information used for demographic or market research purposes. For example, kiosk 110 may request and receive information concerning how user 101 learned of the kiosk location, preferred method of receiving information, for user 101, the gender of user 101, the age of user 101, the banking habits of user 101, etc. If the user does not supply the requested information, kiosk 110 (e.g., application module 115 or account creation module 116) may prompt user 101 to input the requested information before proceeding with account creation. In other embodiments, if the user does not supply the requested information, kiosk 110 may continue with account creation but prompt the user again before completion or flag the user account for follow up requests after completion.

Once the application process is complete and a new account is deemed opened for at least the purpose transferring funds, kiosk 110 may print (e.g. using card issuance module 118 and/or card printer 113) the unfunded debit card associated with the new account (step 320). User 101 may also be prompted to insert the unfunded debit card into kiosk 110 (step 330), e.g., via a card reader, in order to request a transfer of funds to the new account. Alternatively, steps 320 and 330 may be omitted, as indicated by the dotted line of FIG. 3, and instead print the debit card after the transfer is complete and the account is funded (e.g., waiting to print until after step 360).

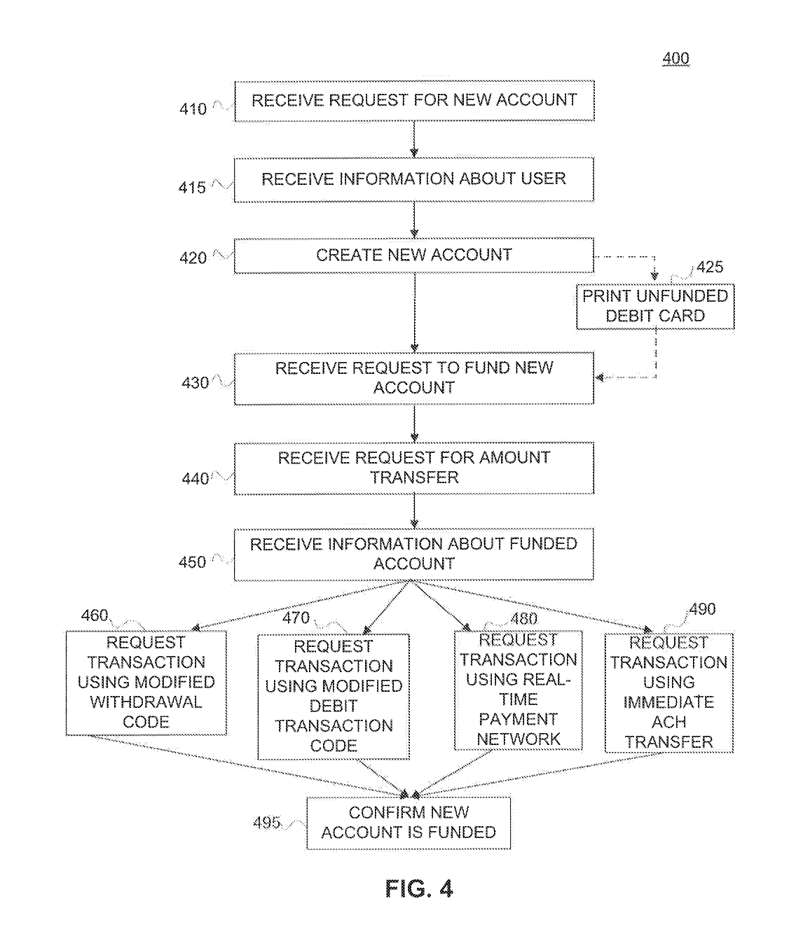

At step 340, user 101 (via, e.g., kiosk) requests a transfer of funds from one or more existing accounts (a source account) to the new account. The transfer may occur via one or more transaction types, such as (1) a modified withdrawal, (2) a modified debit purchase, (3) a real-time payment network, or (4) an immediate automated clearing house (ACH) transfer. These four transaction types are discussed below (see description of steps 460, 470, 480, and 490 of FIG. 4). User 101 may request one of these four types of transactions for the transfer. Alternatively, the amount requested could dictate the type of transaction used for the transfer (see also the description of steps 460, 470, 480, and 490 of FIG. 4).

At step 350, user 101 (via, e.g., kiosk 110) may be prompted to insert a card associated with the source account into a card reader so that, for example, kiosk 110 can obtain the information needed to conduct the transfer (account number, routing number, CCV number, CID number, etc.). Alternatively or additionally, kiosk 110 may request that user 101 enter the information needed to conduct the transfer (e.g., entering a bank account and routing number via user interface 114) into kiosk 110. In still other embodiments, user 101 may provide (via, e.g., kiosk 110) a photograph of the card associated with the source account. One of ordinary skill in the art would also understand that other methods of extracting information needed to conduct the transfer are also available, including near-field communication, card swiping, using a quick response (QR) code (e.g., a QR code generated on the mobile phone of user 101), etc.

Once kiosk 110 has the information needed to conduct the transfer, the transfer may be completed while user 101 is waiting at kiosk 110. Kiosk 110 may provide user 101 with confirmation that the transfer is complete and that the debit card is active and funded.

One of ordinary skill in the art would understand that the steps of process 300 could advantageously be conducted in a different order and/or some steps may be omitted altogether. For example, the steps could be conducted so that user 101 inserts the card for the source account (step 350) before requesting a transfer of funds (step 340) and then inserts the unfunded debit card (step 330) to direct kiosk 110 where to deposit the funds. And, as noted above, kiosk 110 may not print out an unfunded debit card (step 320), but may wait to print out a funded and active debit card after step 360.

FIG. 4 is a flowchart of an overview of exemplary debit card funding process 400 consistent with disclosed embodiments. For ease of discussion, the disclosure of FIG. 4 assumes that the process is used at a system including a kiosk such as system 100 including financial services kiosk 110. One of ordinary skill in the art would understand how process 400 could be applied to other systems, such as system 200.

In step 410, kiosk 110 receives a request from user 101 to open a new account. This request may be received at an application module (e.g., application module 115) which may request that user 101 provide information required to open the new account. That is, after receiving a request to open a new account from user 101, application module 115 may require that user 101 complete an application or respond to questions before opening the account. Kiosk 110 may also request information from the financial service provider system associated with kiosk 110 before opening a new account. For example, kiosk 110 may request information regarding available account numbers to use for the new account, terms and conditions for the account such as the interest rate for the account and withdrawal limits. Kiosk 110 may request and receive information from the financial service provider system relating to user 101, for example, whether user 101 already has an account with the financial service provider and whether the service provider has information about user 101 stored for that other account.

After kiosk 110 receives the required information from user 101 (step 415), and from the financial service provider system 120, if necessary, kiosk 110 creates a new account (step 420). Kiosk 110 may also print the unfunded debit card (step 425). Kiosk 110 may, however, wait to print the debit card until after the new account is funded.

After the new account is created, kiosk 110 may ask if user 101 would like to transfer funds into the new account or user 101 may request to fund the new account (step 430). The request to fund the new account may be accompanied by or followed by a request for a specific amount to be transferred to the new account (step 440). Kiosk 110 may also receive information associated with the preferred means for funding the account (step 450). For example, kiosk 110 may also receive a request that the transfer occur by means of one or more of the four types of transactions: a modified withdrawal (step 460), a modified debit purchase (step 470), a real-time payment network transfer (step 480), and/or an immediate automated clearing house (ACH) transfer (step 490).

To understand a modified withdrawal transaction, a modified debit purchase transaction, a real-time payment network transaction, and an immediate ACH transfer, an explanation of how a (non-modified) withdrawal transaction, a (non-modified) debit purchase transaction, a standard ACH transfer between accounts at different institutions, and a standard ACH transfer between accounts at entities within the same institution are currently implemented is instructive.

Currently, intermediary companies, such as Vantiv®, assist in the transfer of funds for withdrawal transfers. When an account holder requests a cash withdrawal from his account via an ATM, for example, the ATM transmits the information about the transfer with a withdrawal code to the intermediary company. The intermediary company then uses the withdrawal code to communicate with the host system (e.g., the system that hosts the account holder's account) to electronically withdraw the funds from the account holder's account and to cause the ATM to dispense the requested amount to the user. Withdrawals are usually limited to a relatively low amount, for example, to $600 per transaction.

For a modified withdrawal transfer, a modified withdrawal code would be used. The modified withdrawal code would be transmitted with the information about the transfer to an intermediary company or directly to the financial services system or third party financial services system associated with the source account. Using the modified withdrawal code, the funds would be electronically withdrawn from the source account. But instead of dispensing the withdrawn funds, the funds would be electronically deposited into the new account.

Currently, intermediary companies, such as Vantiv®, also assist in the transfer of funds for debit purchase transactions. When an account holder pays for a good or service using his debit card, the information about the purchase with the debit purchase code is sent to the intermediary company. The intermediary company then uses the debit purchase code to electronically debit the funds from the account holder's account and to credit the funds to the seller's account. Purchases are usually limited to a higher amount than cash withdrawal limits, for example, to $2,000 per transaction.

For a modified debit purchase transfer, a modified debit purchase code would be used. The modified debit purchase code would be transmitted with the information about the transfer to an intermediary company or directly to the financial services system or third party financial services system associated with the source account. Using the modified debit purchase code, the funds would be electronically debited from the source account. But instead of crediting the funds to a seller's account, the funds would be electronically deposited into the new account.

Currently, for a standard ACH transfer between accounts at different financial institutions, an intermediary company maintains a network connecting financial institutions to process transfers in batches, such as once a day. The transfer is typically not complete until the receiving party confirms receipt of the transfer. Thus, a standard ACH transfer between accounts at different institutions often takes a couple of days to complete. ACH transfers are usually only limited by the amount in the source account.

For a real-time payment network transfer, some financial services companies are implementing a network that would allow for immediate processing of transfers. Confirmation of receipt would either not be required or would be provided immediately. Thus, for financial institutions connected to the real-time payment network, the transfer can be conducted while the user is waiting at the kiosk. The amount of the transfer may be unlimited or may be limited to the amount in the source account.

Currently, for a standard ACH transfer between accounts at entities within the same institution do not require an intermediary company. The financial institution usually maintains an intra-institution network to connect the various entities within the institution. Because transfers are made within the same financial institution, the transfers can be conducted immediately. Such immediate ACH transfers are usually only limited by the amount in the source account.

Thus, for transfers between accounts within the same financial institution, immediate ACH transfers could be used, and the transfer can be conducted while the user is waiting at the kiosk.

Kiosk 110 may be configured to allow user 101 to choose one or more transaction types. Alternatively, kiosk 110 may be configured to allow user 101 to choose between only two or three of the possible options, may be configured to present user 101 with a default option that can be overridden by user 101, or may be configured to allow user 101 to use only one transaction option. Kiosk 110 may also be configured to automatically select a transaction type based on the amount or type of transfer requested by user 101. For example, kiosk 110 may be configured to use the modified withdrawal transaction code when transfers of less than $600 are requested, use the modified debit purchase transaction code when transfers of less than $2,000 are requested, and use the real-time payment network transfer when transfers over $2,000 are requested. As another example, kiosk 110 may be configured to use the immediate ACH transfer option when the transfer is between accounts at the same financial institution (e.g., the source account and the new account are both hosted by the same financial institution). One of ordinary skill in the art would understand advantageous ways to determine which transaction type to select for the transfer.

In order to transfer the funds, kiosk 110 may receive information about the source account from which the funds are to be transferred (e.g., step 450). The information about the source account may be obtained from a card associated with the source account. For example, user 101 may be asked to insert a card associated with the source account into a card reader in kiosk 110 so that kiosk 110 may read the information from the card. Alternatively, kiosk 110 may request that user 101 enter the required information about the source account, for example, via user interface 114. In still other embodiments, user 101 may provide (via, e.g., kiosk 110) a photograph of the card associated with the source account. One of ordinary skill in the art would also understand that other methods of extracting information needed to conduct the transfer are also available, including near-field communication, card swiping, etc.

After the information about source account is obtained, kiosk 110 may request the transfer of funds from a source account of user 101 to the new account from financial services system 120 and/or third party financial services system 130 using the appropriate transaction type, as shown in steps 460, 470, 480, and 490. Once the transferred funds are deposited in the new account, kiosk 110 may confirm that the new account is funded (step 495). For example, kiosk 110 may be configured to display confirmation of the transaction on user interface 114, to transmit instructions to print a receipt, to print the funded debit if it was not already printed, e-mail the receipt to an e-mail address associated with the new account, and/or to return any new debit card or card associated with the source account that was inserted into kiosk 110 during process 400.

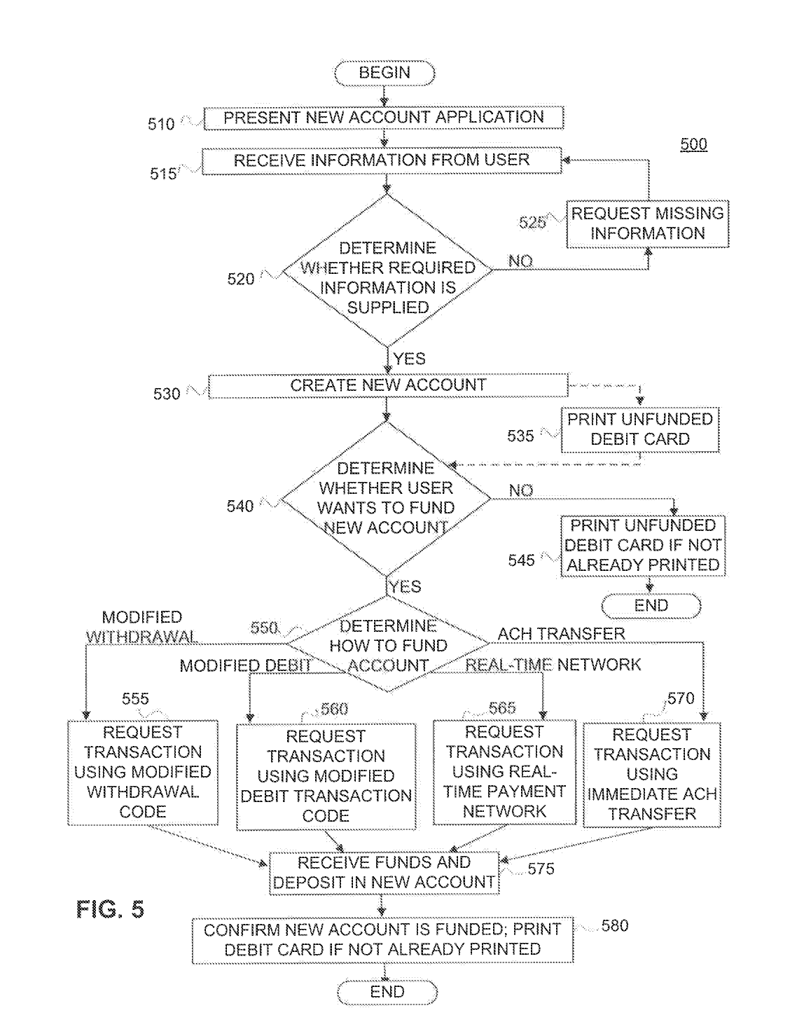

FIG. 5 is a flowchart of an exemplary debit card funding process 500 consistent with disclosed embodiments. For ease of discussion, the disclosure of FIG. 5 assumes that the system including a kiosk, such as system 100 including financial services kiosk 110, performs process 500. One of ordinary skill in the art would understand how process 500 could be performed by other systems, such as system 200.

At step 510, kiosk 110 presents a new account application to user 101 to obtain the information used to open a new account (name, address, income, etc.). Alternatively, kiosk 110 may present user 101 a series of questions to obtain the requested information. Kiosk 110 may also contact system 120 of the financial service provider associated with kiosk 110 to obtain information used to open a new account (e.g., the terms and conditions of the account, information on any fees required from user 101 to open the account, etc.). After receiving the information from user 101 (step 515), kiosk 110 determines whether all of the requested information is supplied (step 520). If required information is missing, kiosk 110 may request the missing information (step 525). In other embodiments, if the user does not supply the requested information, kiosk 110 may continue with account creation but prompt the user again before completion or flag the user account for follow up requests after completion. If the required information has been supplied, kiosk 110 may proceed with creating a new account (step 530). Alternatively, kiosk 110 may transmit the information for the new account to system 120 of the financial service provider associated with kiosk 110, and system 120 opens the account and merely transmits information about the new account back to kiosk 110.

After the new account is created, kiosk 110 may optionally print the unfunded debit card (step 535). Kiosk 110 may wait to print the debit card until step 545 or step 575, as discussed below.

After the new account is created, kiosk 110 may prompt the user to transfer funds into the new account or receive a user request that funds be transferred into the new account. If the request indicates that user 101 does not want to transfer funds, and thus kiosk 110 determines that user 101 does not want to fund the new account (step 540; NO), then kiosk 110 may print the unfunded debit card (step 545) and the process may end. If, however, the request indicates that user 101 does want to transfer funds, and thus kiosk 110 determines that user 101 does want to fund the new account (step 540; YES), then the algorithm proceeds to step 550. The indication that user 101 wants to transfer funds may include an affirmative response to a question from kiosk 110, a request from user 101 to transfer a certain amount of funds, and/or a request from user 101 to conduct a certain transaction type to transfer funds.

Once kiosk 110 determines that user 101 wants to fund the account, kiosk 110 may obtain information about the source account. This information may be obtained by user 101 inserting a card associated with the source account into kiosk 110 and kiosk 110 reading the information from the card. Kiosk 110 may also request that user 101 input information about the source account via, e.g., user interface 114.

At step 550, kiosk 110 may determine which transaction type(s) to use to fund the account. Kiosk 110 may be configured to perform one, two, three, or four of the four discussed types of transactions: (1) a modified withdrawal; (2) a modified debit purchase; (3) a real-time network transfer; and/or (4) an immediate ACH transfer. One of skill in the art would understand that other suitable transaction types may be used to fund the new account and that the types of transactions discussed herein are exemplary only. If kiosk 110 is configured to perform only one type of transaction, then kiosk 110 proceeds with that transaction. If kiosk 110 is configured to perform two, three, or four of the transaction types, then the determination of which type of transaction to use may be based on the selection of user 101. Alternatively, kiosk 110 may be configured to suggest a default transaction type to user 101. As another alternative, kiosk 110 may be configured to use a certain transaction type depending on the amount of funds requested to be transferred (e.g., smaller transfers may use a modified withdrawal, larger transfers may use a modified debit purchase, and even larger transfers may use a real-time payment network or an immediate ACH transfer) or by the type of transaction (e.g., a transfer between two accounts within the same financial institution may use an immediate ACH transfer). It may also be advantageous to allow more than one transaction type to be conducted. For example, user 101 may select to have some of the transfer conducted by one transaction type and the rest of the transfer conducted by a second transaction type. Or, kiosk 110 may be configured to divide the transaction among the transaction options available. One of ordinary skill in the art would readily be able to determine advantageous configurations for transferring the funds using more than one transaction type.

Once the type of transaction is determined, kiosk 110 requests the transfer of funds from the financial services system associated with the source account, as shown in steps 555, 560, 565, and/or 570. Kiosk 110 may also initiate the deposit of the received funds into the new account (step 575). At step 580, kiosk 110 may also confirm the transaction and funding of the new account and print the active debit card associated with the funded new account if the debit card was not already printed (step 580).

One of ordinary skill in the art would understand that certain steps of flowchart 500 may be performed in a different order and/or omitted entirely. For example, the determination of whether user 101 wants to fund the new account (step 540) and how to fund the new account (step 550) may be conducted before the new account is created (step 530).

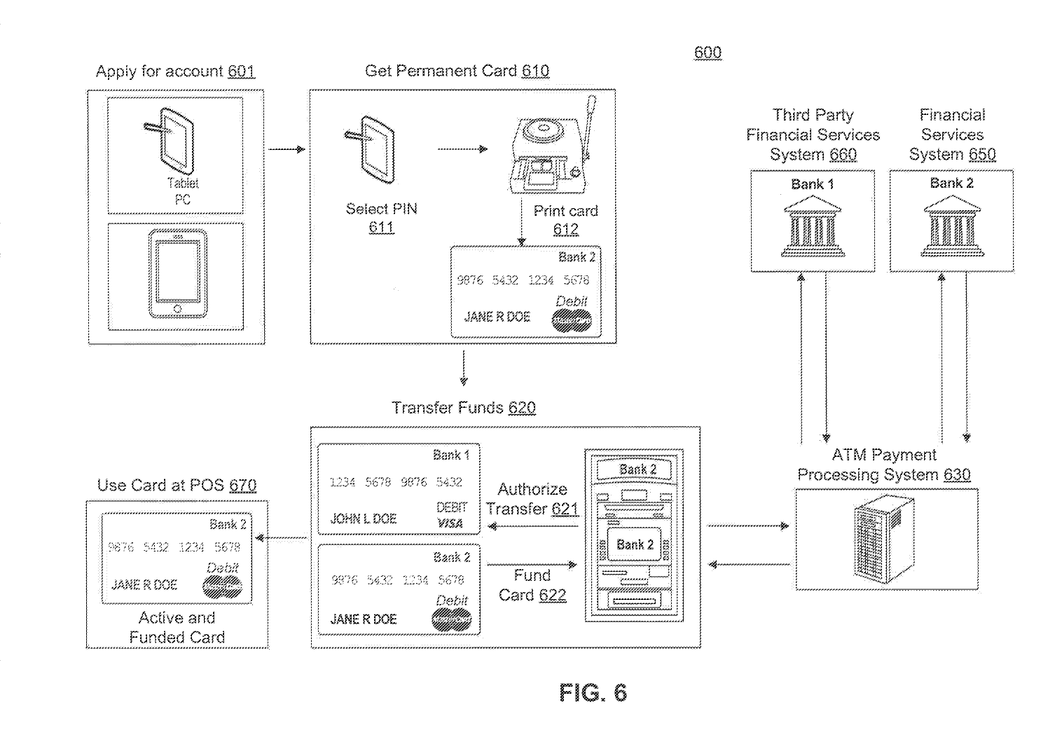

FIG. 6 is a flowchart of exemplary debit card funding process 600 using a system consistent with disclosed embodiments.

At step 601, the user applies for a new account. As shown, the information for the application may be transmitted from the system to the user's personal device, such as a tablet computer or a mobile device with computing ability. After applying for the new account and opening the new account, the user is able to obtain a debit card associated with the account (step 610). In order to obtain the debit card, the user may have to submit information such as a PIN number for the new account (step 611). As shown in funding process 600, the new card may be printed (step 612) at a card printer that is separate from the user's personal device. The printed debit card may then be used to transfer funds (step 620) via an ATM configured with a processor and memory configured to execute functions of the disclosed process. As shown in step 620, the user may use a card associated with a source account to provide information about the source account to the ATM by inserting the card into the ATM (step 621), and the user may provide the information about the new account by inserting the new debit card into the ATM (step 622). The information obtained by the ATM about the source account can then be transmitted with the request to transfer funds and the information about the new account can be used to direct the deposit of the transferred funds. As discussed above, the request to transfer funds may be sent to the third party financial services system associated with the source account (step 660) or to the financial services system associated with the new account and/or the source account (step 650) via an intermediary company, such as an ATM payment processing system like Vantiv® (step 630). Once the transfer is complete and the card is funded, the card can be used, for example, to make purchases (e.g., step 670).

Other features and functionalities of the described embodiments are possible. For example, the processes of FIGS. 3-6 are not limited to the sequences described above. Variations of these sequences, such as the removal and/or the addition of other process steps may be implemented without departing from the spirit and scope of the disclosed embodiments.

Additionally, the disclosed embodiments may be applied to different types of accounts. Any financial service institution that creates accounts for customers with associated cards or similar access device may employ systems, methods, and articles of manufacture consistent with certain principles related to the disclosed embodiments.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but are instead defined by the appended claims in light of their full scope of equivalents.

What is claimed is:

1. A system for funding a new account, the system comprising:
a memory storing instructions; and
at least one processor configured to execute the instructions to:
create a new account based on a user request to fund the new account;
request a selection of at least an amount for funding the new account;
receive the selection of at least the amount for funding the new account;
receive identification information for a funding source account;
initiate transfer of funds from the funding source account to new account; and
deposit the transferred funds into the new account such that the transferred funds become available for use in the new account.

2. The system of claim 1, wherein the processor is further configured to execute the instructions to:
determine the transaction type for funding the new account before requesting the transfer of funds from the funding source account to the new account, the determination based on the amount selected.

3. The system of claim 1, wherein the processor is further configured to receive a selection of a transaction type for funding the new account before requesting the transfer of funds from the funding source account to the new account.

4. The system of claim 1, wherein the processor is further configured to execute the instructions to:
transmit instructions to a printer to print a new debit card associated with the new account.

5. The system of claim 3, processor is configured to execute the instructions to transmit instructions to the printer after the transferred funds are deposited into the new account.

6. The system of claim 4, wherein the new debit card is activated when printed.

7. The system of claim 1, wherein the processor is further configured to execute the instructions to:
receive information about an account holder before creating the new account;
determine whether the received information about the account holder is sufficient to create the new account based on predefined criteria for account creation;
request missing information when the received information about the account holder is not sufficient; and
create the new account when sufficient information is received.

8. An apparatus for funding a new account comprising:
at least one processor;
a user interface;
a card printer; and
a memory, wherein the memory contains instructions for:
an application module for, when executed by the at least one processor, (1) presenting requests via the user interface for information required to create a new account, and (2) receiving information via the user interface,
an account creation module for creating a new account based on at least the received information,
a fund transfer module for requesting a transfer of funds from a source account to the new account, and
a card issuance module for sending instructions to the card printer to print a new card associated with the new account, the transferred funds being available for use in the new account upon printing.

9. The apparatus of claim 8, wherein the account creation module is further for activating the new account.

10. The apparatus of claim 9, wherein the account creation module is further for determining that the funds have been received in the new account before activating the new account.

11. The apparatus of claim 8, wherein the account creation module is further for authorizing the activation of the new card.

12. The apparatus of claim 8, wherein the account creation module is further for authorizing the activation of the new card before the printing of the new card.

13. A computer-implemented method for funding a new account, the method comprising:
creating, via at least one processor, a new account via one or more processors based on a user request to fund the new account;
requesting a selection of at least an amount for funding the new account;
receiving the selection of at least the amount for funding the new account;
receiving identification information for a funding source account;
initiating, via the at least one processor, a transfer of funds from the funding source account to new account; and
depositing the transferred funds into the new account such that the transferred funds become available for use in the new account.

14. The method of claim 13, wherein the method further comprises:
determining, via the at least one processor, the transaction type for funding the new account before requesting the transfer of funds from the funding source account to the new account, the determination based on the amount selected.

15. The method of claim 13, wherein the method further comprises:
requesting a selection of a transaction type for funding the new account; and
receiving the selection of the transaction type for funding the new account.

16. The method of claim 15, wherein the request for a selection of a transaction type includes one or more options that are offered based on the amount selected.

17. The method of claim 13, wherein the method further comprises:
transmitting instructions to a printer to print a new debit card associated with the new account.

18. The method of claim 17, wherein the printing of the new debit card occurs after the transferred funds are deposited into the new account.

19. The method of claim 17, wherein the new debit card is an activated card.

20. The method of claim 13, wherein the method further comprises:
receiving information about an account holder before creating the new account;
determining whether the received information about the account holder is sufficient to create the new account based on predefined criteria for account creation;
requesting missing information when the received information about the account holder is not sufficient; and
creating the new account when sufficient information is received.
